(19) United States
(12) Patent Application Publication
(10) Pub. No.: US 2009/0174774 A1
(43) Pub. Date: Jul. 9, 2009

(54) Video system for viewing vehicle back seat

(76) Inventor: Tracy L. Kinsley, Discovery Bay, CA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/318,403

(22) Filed: Dec. 29, 2008

Related U.S. Application Data
(60) Provisional application No. 61/006,269, filed on Jan. 3, 2008.

(51) Int. Cl. H04N 7/18; H04N 5/64

(52) U.S. Cl. 348/148; 348/837; 348/E07.085; 348/E05.128

(57) ABSTRACT

The video system for viewing a vehicle back seat is a video surveillance system used for viewing a vehicle back seat. A remote camera is encased within a transmitting unit, which is preferably padded on its exterior, and further includes a multimedia display and at least one universal serial bus port for receiving multimedia data. The transmitting unit is mounted about the interior of a vehicle, such as a seat, and transmits video to a portable receiving display screen mounted about the view of the vehicle driver.

### CROSS-REFERENCE TO RELATED APPLICATION

This application claims the benefit of U.S. Provisional Patent Application Ser. No. 61/006,269, filed Jan. 3, 2008.

### BACKGROUND OF THE INVENTION

1. Field of the Invention

The present invention relates to video surveillance devices, and particularly to a video system for viewing a vehicle back seat.

2. Description of the Related Art

Under the various laws and rules in differing geographic regions, or depending on immediate circumstances, it is often necessary to monitor the environment behind a driver. In situations where mirrors are not available or convenient (or due to blind spots or the like, when mirrors are useless to the driver), the driver may be compelled to adjust his or her body to view the rear environment, thus diverting concentration and attention from oncoming traffic and other road hazards, which increases the chances of causing accidental harm and injury not only to themselves, but to others as well.

As a result, some drivers have added mirrors to communicate with existing mirrors in order to expand their general field of vision, thus alleviating the need to adjust his or her body and divert their attention. For example, it is not uncommon for a parent to have multiple mirrors mounted in the interior of a vehicle, which, when positioned just right, allow them to look into a first mirror to view their child, with the image reflecting from another mirror into the first mirror. In this situation, the parent or driver is generally required to look up towards the mirror, away from the road, and for a longer period than usual, as he or she must now concentrate and focus on another reflection. In some cases, it may be necessary to adjust the center, rear view mirror to the extent that the rear traffic is no longer viewable, requiring a driver to continuously adjust the mirror. Nevertheless, the mirrors are not capable of zooming in or out, focusing with particularity on a child or offering more than one simultaneous view.

Thus, a system for viewing vehicle back seat solving the aforementioned problems is desired.

### SUMMARY OF THE INVENTION

The video system for viewing a vehicle back seat has at least one swivel or rotatable camera encased in the soft frame of a transmitting unit that is mounted about the interior of a car. The transmitting unit may include a USB and a video display screen, and a reflecting mirror or other stimulus within its frame that consists of speakers and volume control, accordingly.

The camera(s) video is transmitted to a receiver and viewable by a display screen located about the driver's view. The screen is easy to see while operating a vehicle, as it is positioned so that the driver does not have to be distracted from oncoming traffic, pedestrians or other obstacles in the road.

The system is portable and capable of being removed from a vehicle and brought into a home, office, classroom or any other place for video monitoring (and or recording), and does not have to be reprogrammed or modified when it is moved.

These and other features of the present invention will become readily apparent upon further review of the following specification and drawings.

### BRIEF DESCRIPTION OF THE DRAWINGS

FIG. 1A is a diagrammatic perspective view of a video system for viewing a vehicle back seat according to the present invention, shown with a child's car seat facing forward.

FIG. 1B is a diagrammatic perspective view of a video system for viewing a vehicle back seat according to the present invention, shown with a child's car seat facing rearward.

FIG. 2 is a perspective view of the receiver component of a video system for viewing a vehicle back seat according to the present invention.

FIG. 3 is a perspective view of the transmitting unit of a video system for viewing a vehicle back seat according to the present invention.

Similar reference characters denote corresponding features consistently throughout the attached drawings.

### DETAILED DESCRIPTION OF THE PREFERRED EMBODIMENT

The video system for viewing a vehicle back seat is a combination video transmitting and video receiving device, which is particularly designed to improve the safety and quality of monitoring inside a vehicle while the vehicle is in operation.

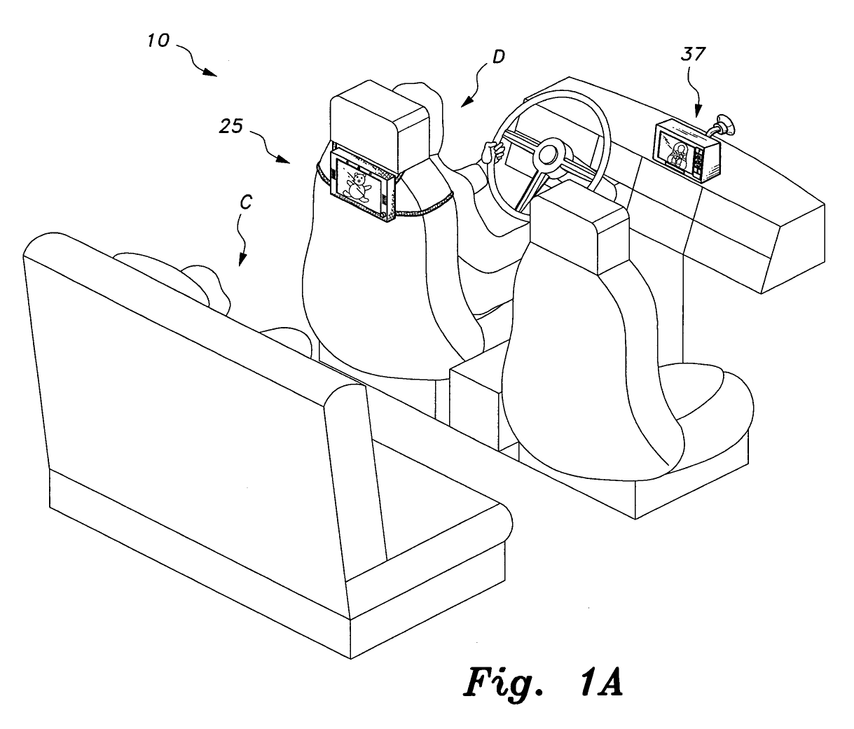

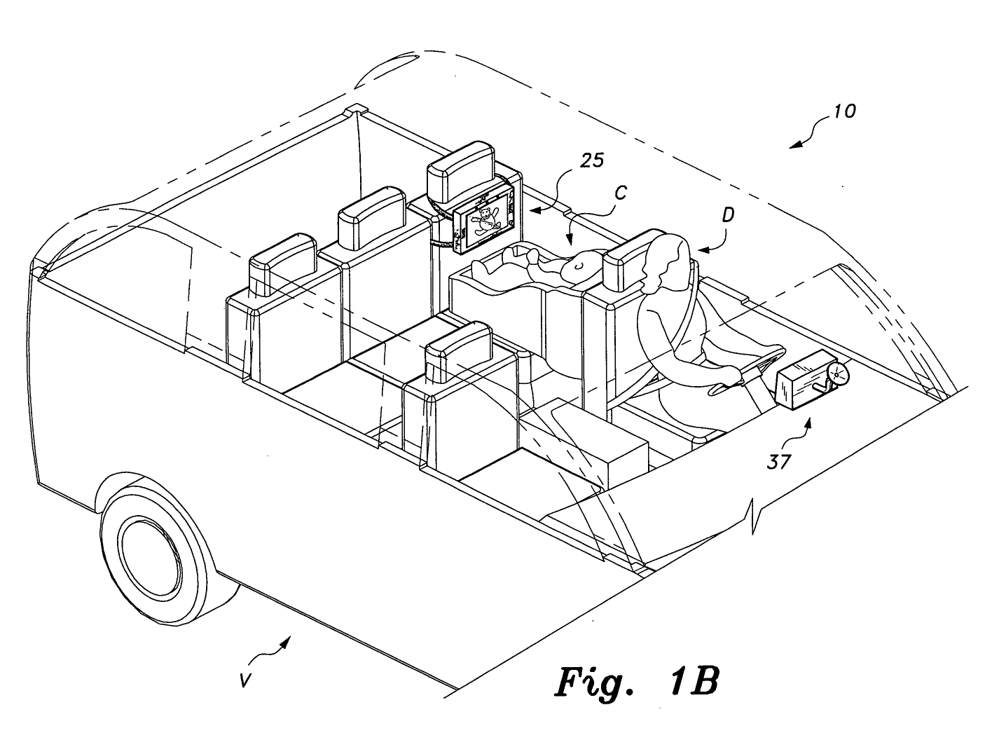

FIGS. 1A and 1B show the system 10 in an arrangement where a restrained child C is seated behind a driver D. As shown in the drawings, the video system 10 may be configured for use either with a child's car seat facing forward or with a child's car seat facing rearward. As shown, transmitting unit 25 is positioned about the interior back seat and focused on a restrained child C. It should be understood that the vehicle V and the seats within the vehicle are shown for exemplary purposes only.

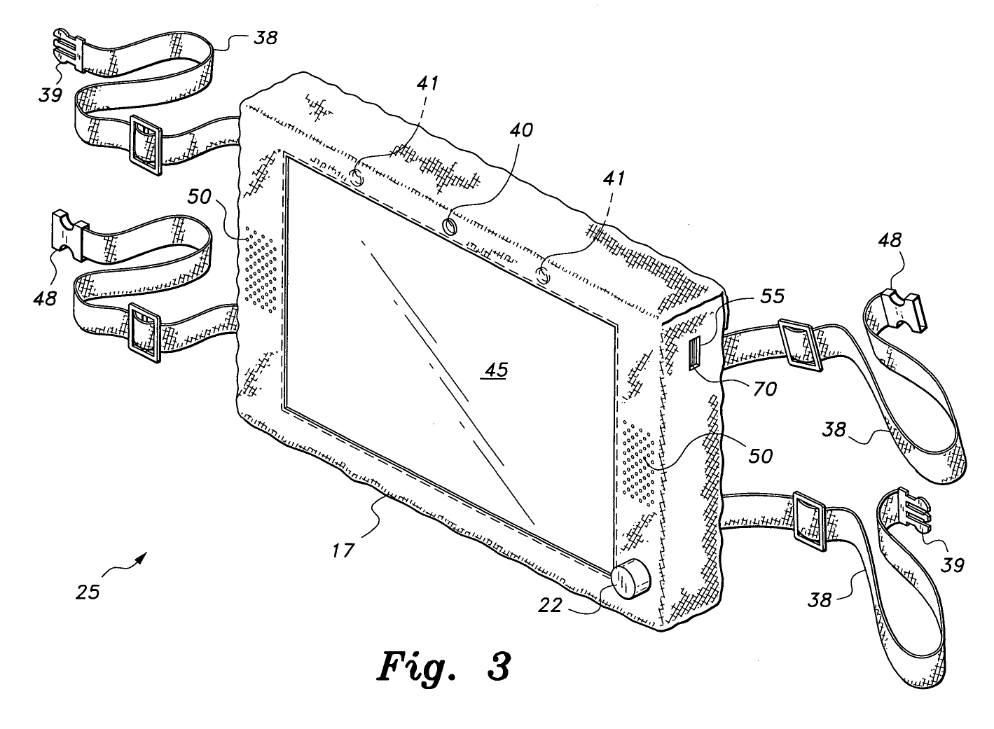

FIG. 3 shows an embodiment of a transmitting unit 25 suitable for use in the system 10. As shown, transmitting unit 25 includes a swiveling and rotatable camera 40 encased within a soft, non-toxic and non-abrasive frame 17. Camera 40 may be any suitable adjustable camera. Frame 17 may be formed from any suitable, relatively soft, non-toxic and non-abrasive material. The transmitting unit 25 may optionally include additional cameras 41 sheathed within the frame 17. The frame 17 encases a display component 45, which may include a video screen adapted for playing entertainment, such as cartoons or the like, or may be in the form of a reflecting mirror, which not only provides entertainment and amusement for the child, but also ensures the child's face is positioned to be in focus for camera 40. If display 45 is adapted for playing video entertainment, display 45 may be any suitable type of video display, such as a liquid crystal display or the like.

In addition to the visual display provided by display 45, audio entertainment may further be provided for the child. Audio signals are generated and emitted by speakers 50, which can be controlled by volume-regulating button 22. A universal serial bus (USB) port 70 fitted in slot 55 is shown located at the upper side portion of the transmitting unit 25 and is used to receive desired multimedia. In use, the driver or parent may connect a source of multimedia content, such as video and/or audio files stored on an external computer, to the transmitting unit 25 via a USB cable connected to USB port 70, and the video and/or audio files may be stored therein, saved in computer readable memory housed within the unit.

The transmitting unit 25 can be attached to a car seat or headrest, for example, by securing opposed ends 39 and 48 of adjustable, connecting straps 38, either laterally or longitudinally, as shown. Straps 38 may be formed of any suitable material and are adjustable, through use of a length-adjusting buckle, as shown, or the like. It should be understood that any suitable type of releasable connectors, such as a hook and loop system, adhesives, magnets or the like, may be alternatively utilized. Furthermore, the transmitting unit 25 may be affixed to a multitude of regions within a vehicle depending on what is to be monitored and likewise could be directed to outer regions, including outside the vehicle, rather than only the exemplary car seat illustrated.

The transmitting unit 25 may be cordless and powered by batteries housed therein, or the unit 25 can receive power by a power cord attached to a constant power source in the vehicle, such as the lighter port (powered by the vehicle's battery). The transmitting unit 25 may be removed from the vehicle and used elsewhere, such as in a home or in a classroom, where it can be run on batteries or powered by conventional power outlets.

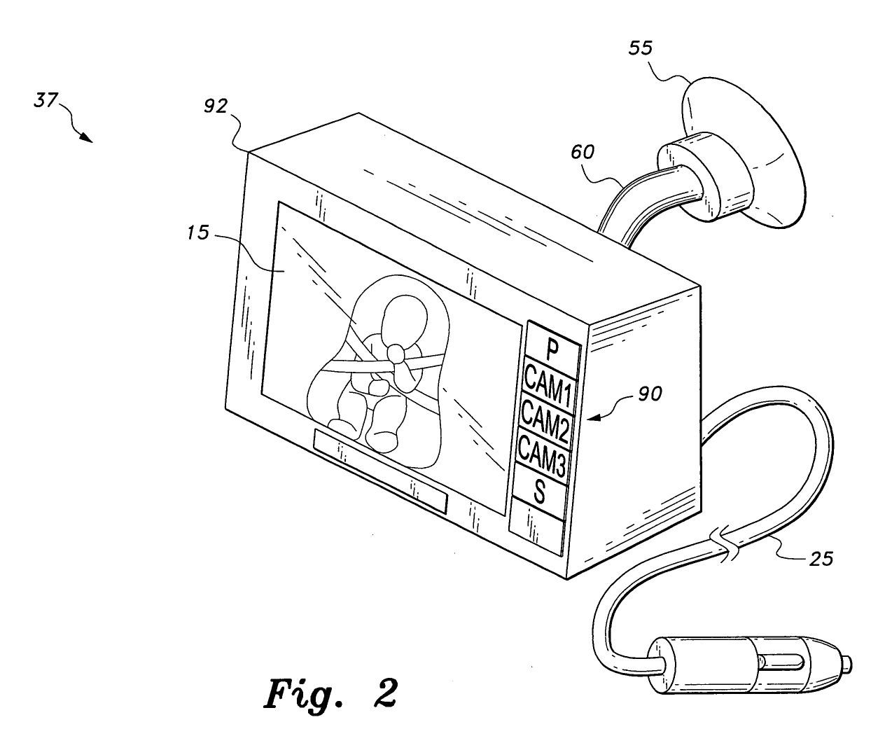

When camera 40 is activated, it transmits a video signal via laser, radio frequency or wire to a receiver 37. As shown in FIGS. 1 and 2, the receiver 37 converts the transmitted signal to a readable format that is translated into video on a display screen 15, which may be a liquid crystal display or the like. The receiver 37 is capable of communicating with more than one transmitter and likewise capable of distinguishing between more than one signal. The receiver 37 preferably has three camera view options, which are selected by pressing one of the buttons labeled “CAM1,” “CAM2” or “CAM3” to select the corresponding camera view. As shown, the display 15 is mounted within a housing 92, and an input panel 90 is further mounted on housing 92. Input panel 90 includes a plurality of entry buttons, including the “CAM1,” “CAM2” and “CAM3” buttons.

View options may be from three different transmitting units or from a single transmitting unit, as shown in FIG. 3, with two additional cameras 41 shown in phantom. The “S” button, below “CAM3,” may be used to scroll through the different camera views, if available, as well as different camera view combinations, such as split screen “CAM1” with “CAM2,” or split screen with all three cameras at once. The “P” button, located above “CAM1,” is used to program the system.

The receiver 37 can be powered by batteries or by a constant source attached via wire 25 to the vehicle lighter port or other power outlet. The receiver 37 has universal attachment capabilities and may be positioned so that the driver can simultaneously view the road and the display screen 15 at the same time. For example, FIG. 2 shows the receiver 37 attached directly to the windshield by an adjustable support 60 and suction cup 55 combination. The receiver 37 may be affixed to other interior regions such as the dashboard by suction, hook and loop fasteners, magnets, adhesives or any other suitable means for releasable attachment. Alternatively, it may be independent of a display screen 15 and the display could be projected onto the windshield or about it via a conventional heads-up type display. It should be understood that in the above embodiments, the transmitters and receivers may either be permanently mounted, or may be releasably mounted, allowing them to be moved from vehicle to vehicle.

It is to be understood that the present invention is not limited to the embodiments described above, but encompasses any and all embodiments within the scope of the following claims.

I claim:

1. A video system for viewing a vehicle back seat, the system comprising:
at least one video transmitting device including at least one video camera and a transmitter for transmitting a video signal;
means for securing the at least one video transmitting device to a seat of the vehicle;
a video receiving device including a video display device and a receiver for receiving the video signal generated by the at least one video transmitting device; and
means for securing the video receiving device to a support surface within the vehicle adjacent the driver's seat of the vehicle.

2. The video system for viewing a vehicle backseat according to claim 1, wherein said at least one video transmitting device includes a display surface mounted within a frame.

3. The video system for viewing a vehicle backseat as recited in claim 2, wherein said frame is padded.

4. The video system for viewing a vehicle backseat as recited in claim 2, wherein the display surface is a mirror.

5. The video system for viewing a vehicle backseat as recited in claim 2, wherein the display surface is a video display screen.

6. The video system for viewing a vehicle backseat as recited in claim 5, further comprising means for storing and displaying video signals on the video display screen.

7. The video system for viewing a vehicle backseat as recited in claim 6, wherein said means for storing and displaying video signals on the video display screen comprise at least one multimedia port mounted in the frame.

8. The video system for viewing a vehicle backseat as recited in claim 7, further comprising at least one audio output device mounted within the frame of said at least one video transmitting device.

9. The video system for viewing a vehicle backseat as recited in claim 2, wherein said means for securing the at least one video transmitting device to the seat of the vehicle comprises at least one strap secured to the frame.

10. The video system for viewing a vehicle backseat as recited in claim 9, further comprising means for adjustably and releasably securing the at least one strap to the seat.

11. The video system for viewing a vehicle backseat as recited in claim 1, wherein said video receiving device includes a housing, the video display device and receiver being mounted within the housing.

12. The video system for viewing a vehicle backseat as recited in claim 11, further comprising at least one user input button mounted on the housing.

13. The video system for viewing a vehicle backseat as recited in claim 12, wherein the at least one video transmitting device comprises a plurality of video transmitting devices, the at least one user input button allowing the driver to selectively display a view from a selected one of the plurality of video transmitting devices.

14. The video system for viewing a vehicle backseat as recited in claim 13, wherein the at least one user input button further allows the driver to selectively display rotating views from the plurality of video transmitting devices.

15. The video system for viewing a vehicle backseat as recited in claim 12, wherein the at least one video camera comprises a plurality of video cameras, the at least one user input button allowing the driver to selectively display a view from a selected one of the plurality of video cameras.

16. The video system for viewing a vehicle backseat as recited in claim 12, wherein the at least one user input button further allows the driver to selectively display rotating views from the plurality of video cameras.

17. The video system for viewing a vehicle backseat as recited in claim 11, further comprising means for providing power from an external power source to said video receiving device.

18. The video system for viewing a vehicle backseat as recited in claim 11, wherein said means for securing the video receiving device to the support surface within the vehicle comprises at least one suction cup.

19. The video system for viewing a vehicle backseat as recited in claim 18, further comprising an adjustable support having opposed first and second ends, the first end thereof being mounted to the housing, the at least one suction cup being secured to the second end thereof.
